(19) United States
(12) Patent Application Publication
(10) Pub. No.: US 2026/0236503 A1
(43) Pub. Date: Aug. 13, 2026

(54) System and Method for Aligning Language Models with Natural Language Rules

(71) Applicant: Hitachi, Ltd., Tokyo (JP)

(72) Inventors: Shunichi AKATSUKA, Santa Clara, CA (US); Aman KUMAR, Santa Clara, CA (US); Ahmed FARAHAT, Santa Clara, CA (US)

(21) Appl. No.: 19/050,473

(22) Filed: Feb. 11, 2025

(51) Int. Cl. G06F 16/3329

(52) U.S. Cl. CPC G06F 16/33295

(57) ABSTRACT

Systems and methods described herein involve for receipt of a domain-specific user query, a) generating an answer from a large language model (LLM) to the domain-specific user query; b) constructing a prompt from the answer and the domain-specific user query; c) generating a mapping of the prompt to domain-specific rules; d) generating an updated answer from the mapped domain-specific rules; e) evaluating the updated answer; and f) iterating steps b) to e) until the updated answer is evaluated to exceed a threshold, wherein the prompt is updated based on the evaluation for the updated answer being evaluated to not exceed the threshold; and storing the domain-specific user query, the updated answer and the evaluation in a database to update preprocessing for inputs of domain-specific user queries.

### BACKGROUND

### Field

The present disclosure is generally related to Large Language Models (LLMs) and more specifically, to systems and methods to align language models with natural language rules.

### Related Art

Recently, Large Language Models (LLMs) such as GPT models have been widely used in general domains. These LLMs are trained to predict the next token (word), using a large dataset of text available on the internet. On the other hand, these models are not trained on domain-specific knowledge that are not well documented on the internet, or company internal data. In industrial domains, many use cases of LLMs require the output to follow specific rules in that domain. For example, suppose there is a chatbot that helps car expert to diagnose vehicle problems and suggest how to fix the vehicle. Some general LLMs can have knowledge to help this, but these models don't have knowledge on the car repair shop's internal rule, such as “do not work on [certain repair process] at [certain place], as it is dangerous in a [certain way]”. If it is assumed that there is a large list of natural-language written rules, it is not trivial how to make the model to follow these rules. Such realistic conditions can include: (a) having a large list of natural-language written rules (>1000), (b) the rules can be updated/added/deleted occasionally, (c) out of thousands of rules, only a few of them are relevant to the specific query, (d) the user wants the response quickly, e.g. in a few seconds not minutes, and (e) system running cost, as well as model preparation cost is limited.

There are several related art methods that try to make an LLM behave as the users prefer. In general, this step is called “aligning” a model.

In the related art, there is Reinforcement Learning with Human Feedback (RLHF) to align the model. In short, this method can collect a bunch of queries that the LLM is to answer, (2) collect human feedback data-that is, a dataset with multiple answers to a question, and with human labels on which answer is preferred over which, (2) use the human feedback dataset to train a reward model, that gives a score to a sentence, based on the human preference, and, (3) reinforcement learning step, where the reward model is used to train the LLM to maximize the score. Such related art implementations can provide good performance (i.e., they can generate answers that are preferred by human) and a Quick response (e.g., because they are pre-trained, the answers are generated quickly when it is to be used).

However, such related art implementations require large amount of data, both for queries (step1) and human labeled data (step2), and does not explicitly use an “external rule”, but rather assumes that humans know these rules already. Further, such related art implementations require significant computation resources to pre-train the model to decent level, and the whole process will need to be re-run t when the rules are modified.

In another related art implementation, instead of using human labelers to determine which answer is preferred, a set of rules is used to make a dataset that contains the preference information. The rules are used together with an LLM to update existing answer to follow the rules and use the “revised answer” as preferred answer over the “existing answer”. This way, the human labeling part can be bypassed. Such related art implementations can make use of external rules and specifically follow them, and can provide a quick response; because they are pre-trained, the answers are generated quickly when used.

However, in such related art implementations, when the preference dataset is generated, multiple rules are randomly sampled from all the rules, and an LLM is made to fix the existing answer based on these rules. This only works when the number of rules is small, and all the rules are somewhat relevant to the query/answer. When the model is actually used, the model does not explicitly use the rules to fix its answer. The related art implementations rely on the model's capability to understand the rules during pre-training, but it is not guaranteed that they really generate an answer that follows the rules.

In other related art implementations, there can be solutions such as (1) add all the rules as input to the LLM, or (2) ask LLM to revise its output based on several rules, and then loop this over all the rules. In such related art implementations, there is no pre-training needed, i.e., less computation required at model preparation step. Further, such related art implementations directly make use of the rules when generating a response, which makes the system more reliable.

However, such related art implementations can be very slow at inference, as they need to go through all the thousands of rules. Additionally, the computation power required for every inference will be large.

### SUMMARY

The related art includes the following issues. When there are a large number of rules that is to be used to make the LLM to follow during inference, (1) a pre-training approach requires significant effort in terms of data collection and training cost, which makes if less flexible to dynamically changing rules. Also, as the pre-training steps are relied upon to let the model know the rules, it might not be reliable at inference step. Additionally, (2) if at-inference techniques are used to try to make the output to follow all the rules, since the number of rules are large, it will take too much time or cost to do so. This makes the system infeasible to be used.

Example implementations described herein involve using the rules at the inference step, to generate more reliable output. Such example implementations make this step efficient by selecting relevant rules for a given query. To do this, the example implementations involve two main functions, (1) Preprocess and (2) Extract-rule & Generate answer.

Aspects of the present disclosure can involve a method, which can include, for receipt of a domain-specific user query, a) generating an answer from a large language model (LLM) to the domain-specific user query; b) constructing a prompt from the answer and the domain-specific user query; c) generating a mapping of the prompt to domain-specific rules; d) generating an updated answer from the mapped domain-specific rules; e) evaluating the updated answer; and f) iterating steps b) to e) until the updated answer is evaluated to exceed a threshold, wherein the prompt is updated based on the evaluation for the updated answer being evaluated to not exceed the threshold; and storing the domain-specific user query, the updated answer and the evaluation in a database to update preprocessing for inputs of domain-specific user queries.

Aspects of the present disclosure can involve a computer program, which can include instructions involving, for receipt of a domain-specific user query, a) generating an answer from a large language model (LLM) to the domain-specific user query; b) constructing a prompt from the answer and the domain-specific user query; c) generating a mapping of the prompt to domain-specific rules; d) generating an updated answer from the mapped domain-specific rules; e) evaluating the updated answer; and f) iterating steps b) to e) until the updated answer is evaluated to exceed a threshold, wherein the prompt is updated based on the evaluation for the updated answer being evaluated to not exceed the threshold; and storing the domain-specific user query, the updated answer and the evaluation in a database to update preprocessing for inputs of domain-specific user queries. The computer program and instructions can be stored on a non-transitory computer readable medium and executed by one or more processors.

Aspects of the present disclosure can involve an apparatus, which can involve a processor, configured to, for receipt of a domain-specific user query, a) generate an answer from a large language model (LLM) to the domain-specific user query; b) construct a prompt from the answer and the domain-specific user query; c) generate a mapping of the prompt to domain-specific rules; d) generate an updated answer from the mapped domain-specific rules; e) evaluate the updated answer; and f) iterate steps b) to e) until the updated answer is evaluated to exceed a threshold, wherein the prompt is updated based on the evaluation for the updated answer being evaluated to not exceed the threshold; and store the domain-specific user query, the updated answer and the evaluation in a database to update preprocessing for inputs of domain-specific user queries.

### BRIEF DESCRIPTION OF DRAWINGS

FIG. 1 illustrates an example output from applying domain-specific safety rules, in accordance with an example implementation.

FIG. 2 illustrates a flowchart showing the overall process, in accordance with an example implementation.

FIG. 3(a) to 3(c) illustrate examples of pre-processing, in accordance with an example implementation.

FIG. 4 illustrates an example in-depth flow diagram for the processing of user input, in accordance with an example implementation.

FIG. 5 illustrates an example flow for generating the mapping of the query and naïve answer from the constructed prompt, in accordance with an example implementation.

FIGS. 6 and 7 illustrate examples of the valuation process, in accordance with an example implementation.

FIG. 8 illustrates an example of prompt construction when the evaluation indicates that the answer needs to be revised, in accordance with an example implementation.

FIG. 9 illustrates an example architecture to save user feedback data, in accordance with an example implementation.

FIG. 10 illustrates an example user interface to obtain the user response 407, in accordance with an example implementation.

FIG. 11 illustrates an example computing environment with an example computer device suitable for use in some example implementations.

### DETAILED DESCRIPTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of ordinary skill in the art practicing implementations of the present application. Selection can be conducted by a user through a user interface or other input means, or can be implemented through a desired algorithm. Example implementations as described herein can be utilized either singularly or in combination and the functionality of the example implementations can be implemented through any means according to the desired implementations.

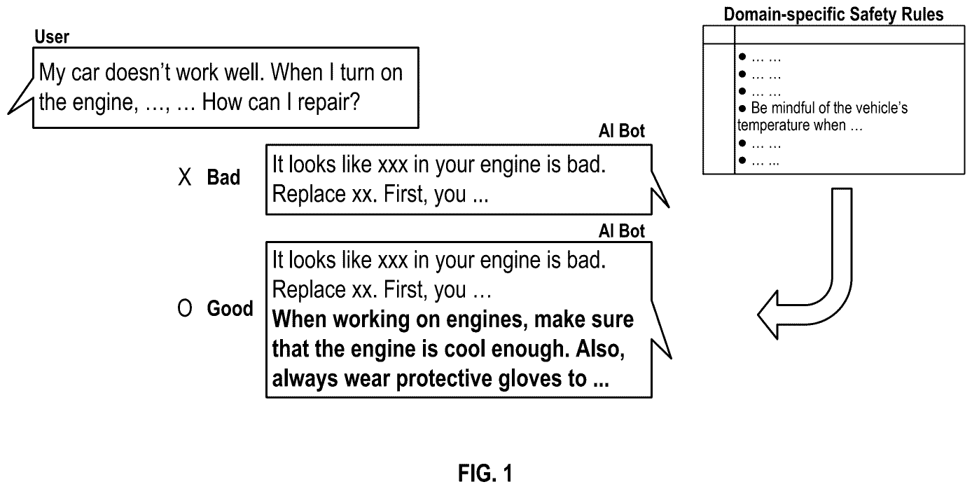

FIG. 1 illustrates an example output from applying domain-specific safety rules, in accordance with an example implementation. In example implementations, suppose a user submits a query regarding symptoms of a car having problems. Although a generic LLM may produce an answer, the answer may be bad because it does not take into account domain-specific information such as safety rules that are needed when conducting maintenance on the car. To address this issue, example implementations described herein apply domain-specific safety rules such that additional safety context is provided in the response to the query as shown in the good answer of FIG. 1

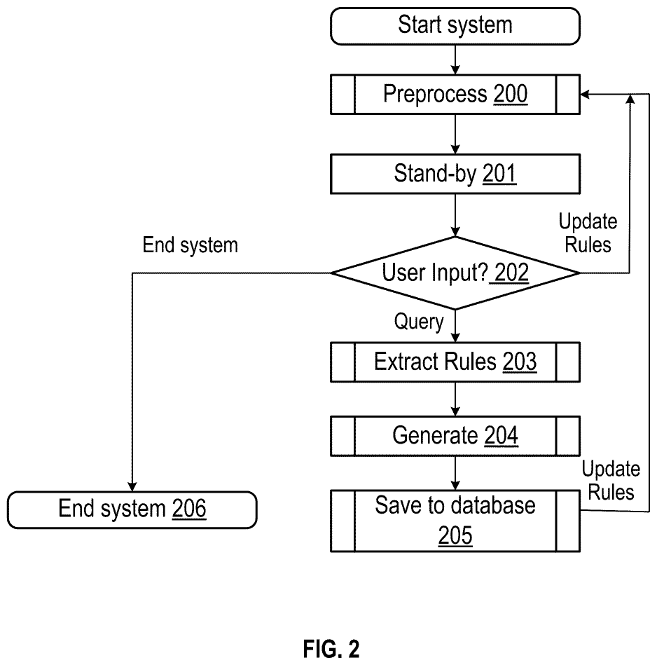

FIG. 2 illustrates a flowchart showing the overall process, in accordance with an example implementation.

During the preprocess step 200, the example implementations can analyze the current rules and past queries-responses. Here, example implementations will generate a mapping from a given query to relevant rules. These steps are done (1) automatically when the system launches, (2) when the user asks the system to update the rule mapping, or (3) when there is sufficient additional data to update the mapping.

The system then goes on standby 201 until a user input 202 is received. The user input 202 is then processed to either update the rules mapping, end the system 206, or extracting and processing a query.

When the user inputs a query to the system, the example implementations will run an extract-rules function 203. This function 203 will use the aforementioned mapping to collect rules that are relevant to the given query. Note that the number of extracted rules is significantly smaller than the total number of rules, which makes it much easier for the LLM to generate answers in the next step. Using the query and the extracted rules, the example implementations then utilize an LLM to generate 204 an answer that follows the rules. The answer is then saved to a database 205 which can also be utilized to update the rules as needed.

The preprocessing step can involve several sub-steps as follows.
(1) Rule analysis step—in this step, the rules are analyzed and split into multiple categories. Example implementations can utilize various methods in accordance with the desired implementation. One example is to prepare rule categories by asking experts, and then ask LLMs to categorize all the rules into one or more of the given categories, so that each category has small number of rules (e.g. a few tens). Other methods include using text clustering techniques to generate categorized rules.
(2) Past query analysis step—Similarly to rule analysis step, example implementations can analyze the past query-response to map them into multiple categories. Various methods can be applied to perform this step in accordance with the desired implementation, for example using natural language clustering techniques, using keyword-based matching, or collecting human feedbacks and train a model to predict them.

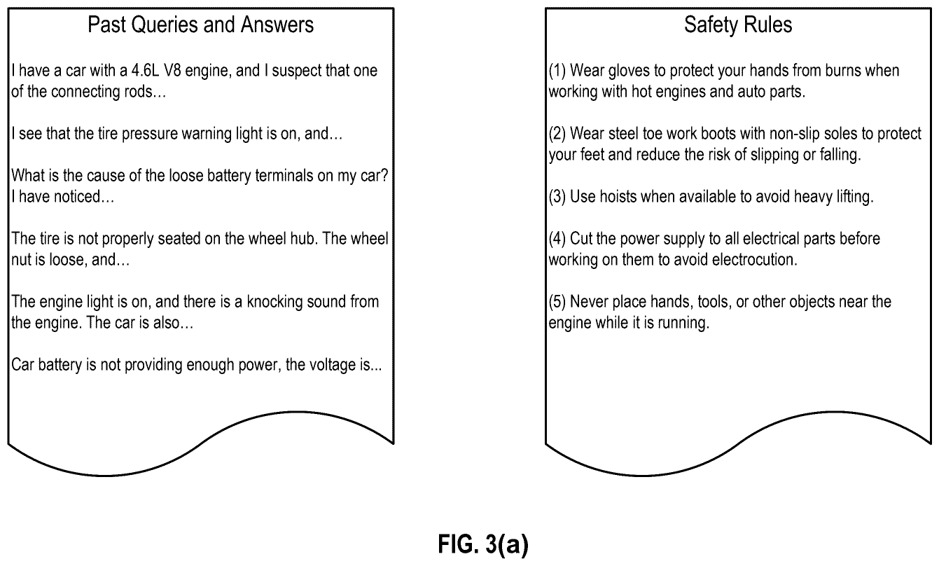

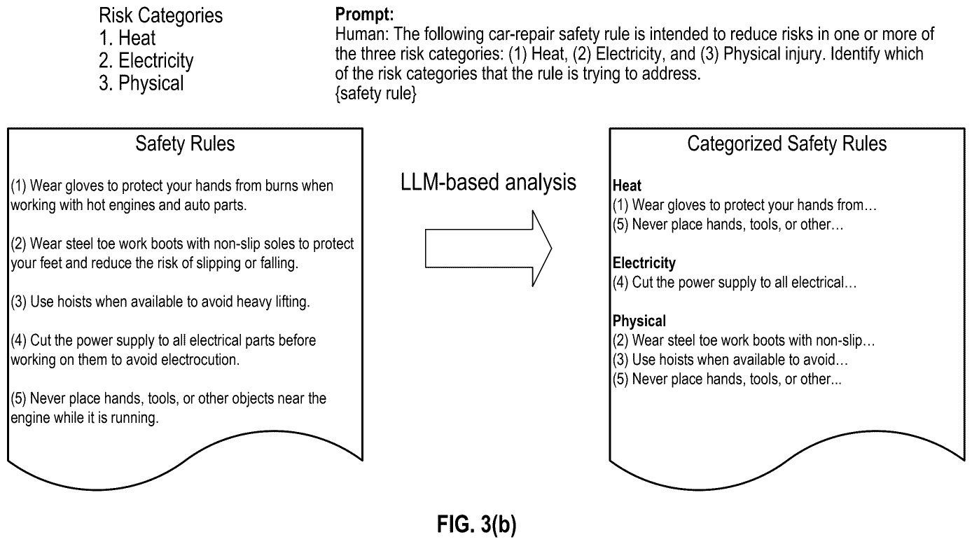

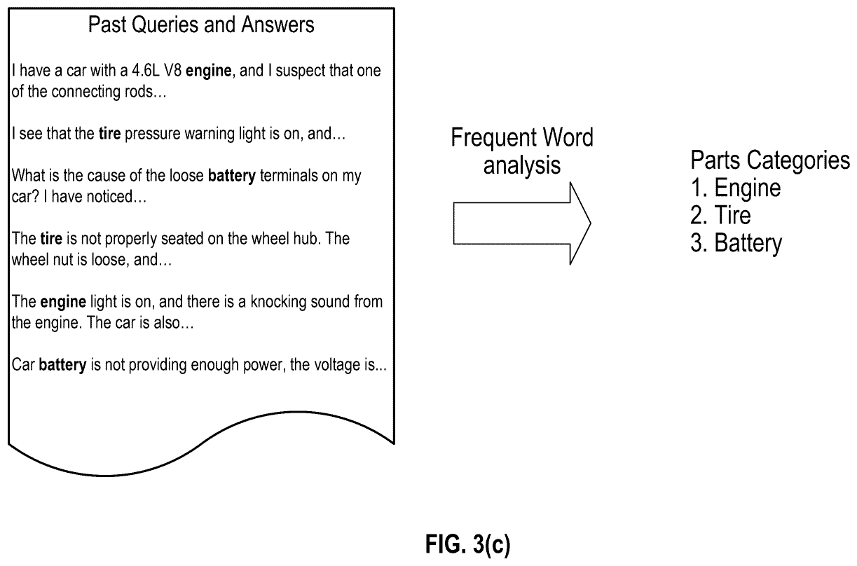

FIG. 3(a) illustrates an example of past queries and safety rules. In an example of rule analysis for industrial applications, safety rule analysis is conducted to avoid certain risks by taking an operation. In such an example, pre-processing can include categorizing the rules based on the risk that the rule is trying to prevent, and/or ask the LLM to categorize all the rules into one or more of the given categories. FIG. 3(b) illustrates an example of safety rule analysis that can be conducted. In the example implementation of FIG. 3(b), the example risk categories can be predefined as heat, electricity, and physical injury, which is then utilized as a prompt to the LLM to categorize the safety rules into the defined risk categories. The LLM then preprocesses the safety rules to categorize the safety rules accordingly as shown in FIG. 3(b).

FIG. 3(c) illustrates an example of pre-processing using a keyword-based method. First, frequent n-gram keywords are extracted from past queries and responses. Such data could be obtained from the past queries, or can be generated using LLMs. From these n-gram keywords, example implementations remove “common words” from the keywords, to extract domain-related words. The examples of the common words are pronouns, auxiliary verbs, and so on. The extracted domain-related words can be, for example, the name of the car components in the car-repair use case. Then, example implementations use the extracted keywords as the query-response categories. In the example of FIG. 3(c), the frequent word analysis extracts keywords that are then used as parts categories.
(3) Category mapping step-Lastly, the example implementations generate a mapping between query-response categories and rule categories. Various methods can be applied here in accordance with the desired implementation, including using traditional text classification methods, generating rule-based algorithms, or using LLMs. Another option is to collect past query-response data, along with the rule category information so that a small model can be trained to determine which rule category to be used, given the query.

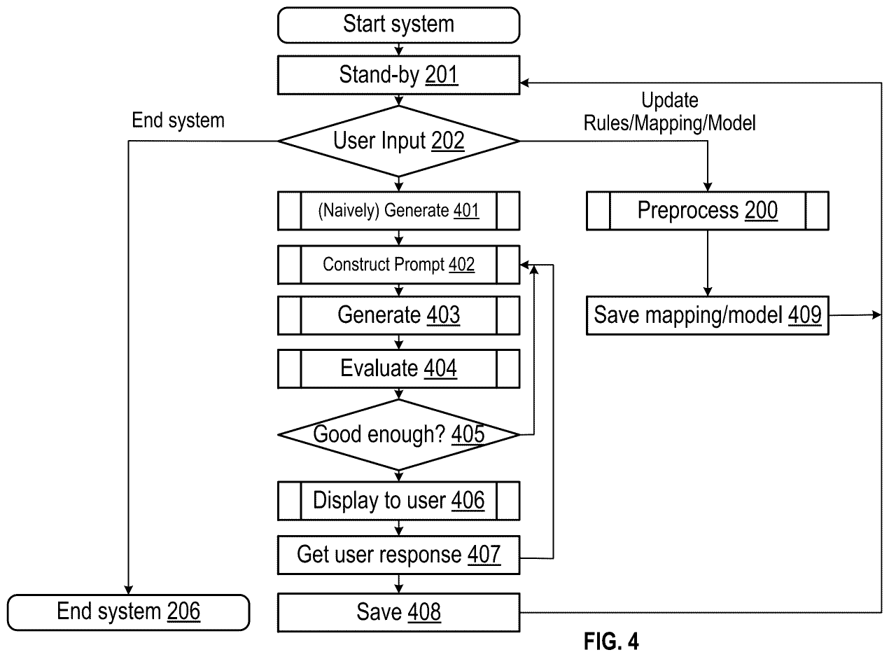

FIG. 4 illustrates an example in-depth flow diagram for the processing of user input, in accordance with an example implementation. In an example implementation, the rule extraction 203 and generation 204 can be broken into sub-steps as follows.

At first, the response to the query is naively generated at 401. The purpose of naively generating the response without applying any rules is to utilize the keywords in the response to determine a category for the query and response. The query and answer are then used to construct a prompt at 402 to generate 403 the mapping of the query to obtain the appropriate rules through processing the prompt through question/answer category mapping and rule category mapping and generate an updated answer.

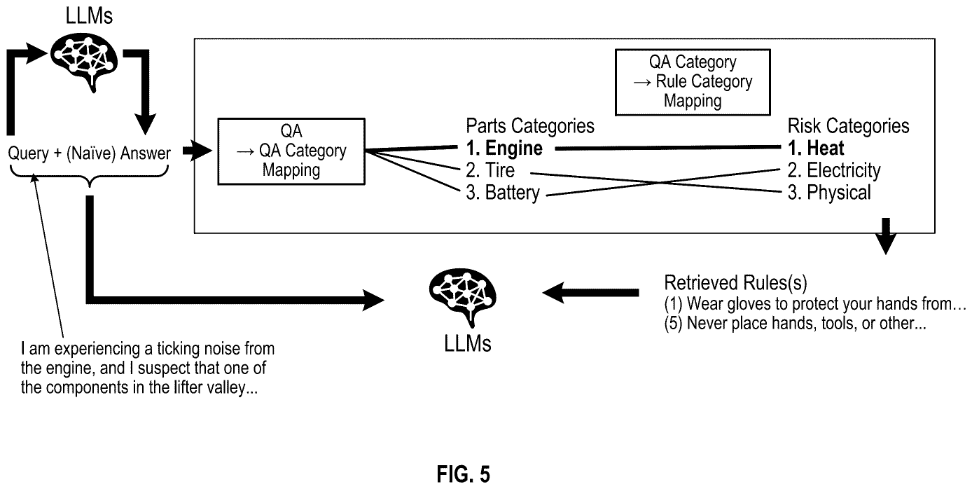

FIG. 5 illustrates an example flow for generating the mapping of the query and naïve answer from the constructed prompt 402, in accordance with an example implementation. In the example of FIG. 5, the constructed prompt 402 is provided first to a question/answer category mapping that generates a mapping from the query/answer to the query category (in this example, parts category, determined to be related to the engine category). As described previously, the query/answer category can be keyword-based and hard coded, or examples are generated with an LLM whereupon a classifier is trained through using the examples.

Once the category mapping is identified for the query and answer, then a rule category mapping can be applied (e.g., in this example, risk categories, in which it is determined that the heat category applies). A mapping is then generated between the query/answer categories and rule categories (e.g. by asking LLM, using past query/answer and rule category data to generate the mapping). Such mapping can then be verified by rule verification model(s) as designed in accordance with the desired implementation. Once the rule category mapping is obtained, the retrieved rules can be provided to the LLMs to generate an updated answer for the evaluation process 404 based on evaluation of the query, updated answer, and retrieved rules.

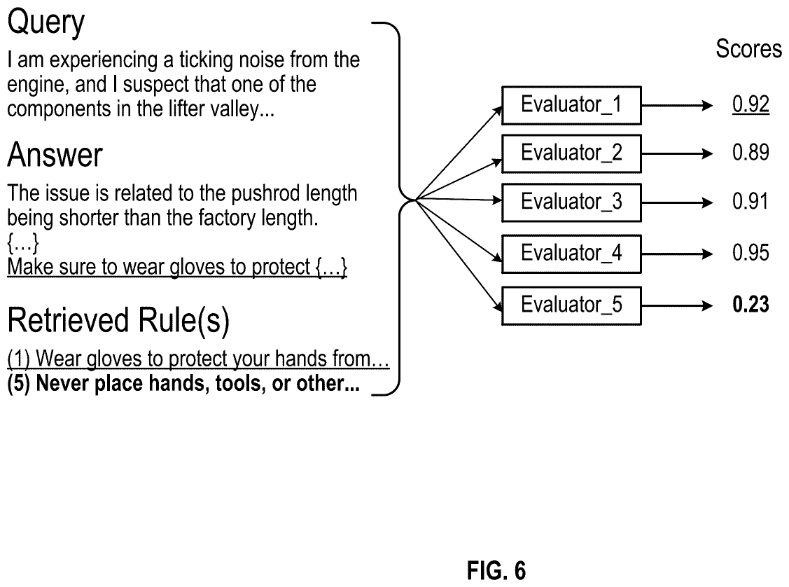

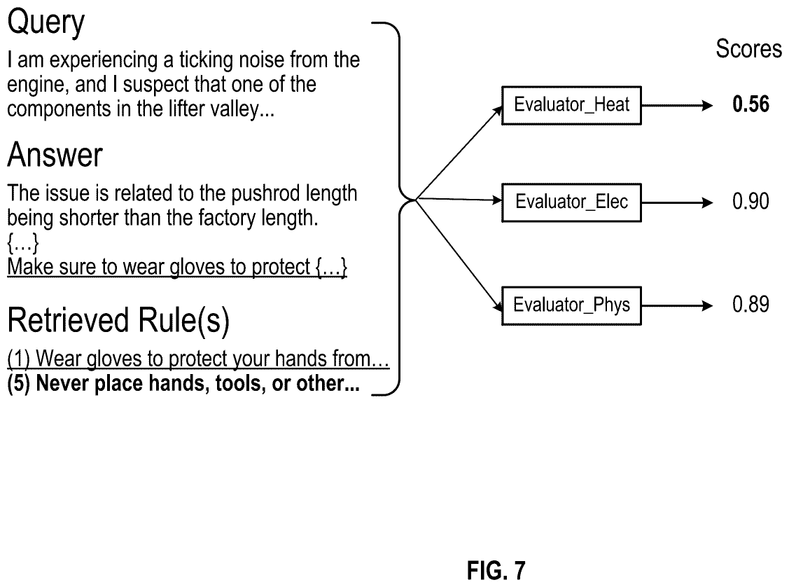

FIGS. 6 and 7 illustrate examples of the evaluation process 404, in accordance with an example implementation. Three example implementations for conducting the evaluation process are provided herein, however, such example implementations may be adjusted to the desired implementation and the present disclosure is not limited thereto.

In a first example, all of the constraints are evaluated at once. In such an implementation, the input/output is as follows:
Input: <Query, Answer, All Rules>
Output: Evaluation value ∈[0, 1]

In a second example, all of the constraints in one category are evaluated at once. In such an implementation, the input/output is as follows:
Input: <Query, Answer, All Rules>
Output: Evaluation value ∈[0, 1]

In a third example, each constraint is evaluated one at a time. In such an implementation, the input/output is as follows:
Input: <Query, Answer, All Rules>
Output: Evaluation value ∈[0, 1]

In the example of FIG. 6, evaluations are conducted on a per rule basis, such that the evaluators are trained to give a higher score when the rule is not needed, or if it is needed and included. As indicated in the underline, the answer included information regarding wearing gloves, which corresponds to one of the retrieved rules. The evaluator corresponding to the retrieved rule is then provided with a higher score as illustrated in the underlined score. In contrast, when the rule is needed but not included, a lower score is provided as shown in bold. In the example of FIG. 6, the retrieved rules involve placement of hand or tools, which was not addressed in the answer. Hence, the bold score of the evaluator corresponding to the retrieved rule is low, indicating that the rule was not addressed.

In the example of FIG. 7, evaluations are conducted per category, such that the evaluators are trained to give a higher score when the rules in a rule category are needed and included or not needed. Additionally, the evaluators are configured to give a lower score when the rules in a rule category are needed but not included. In the example of FIG. 7, the evaluator based on the heat category has a score that indicates that the rule is partially unaddressed, in that gloves are recommended, but placement of hands and tools are not addressed.

Once the evaluation 404 is conducted, a determination is made as to whether the provided answer is sufficient at 405. If so (Yes) then the flow proceeds to 406, otherwise, the flow proceeds to 402 to construct a new prompt. The sufficiency of the evaluation can be conducted in accordance with any desired implementation, such as all of the evaluators meeting a threshold, a threshold score met based on a function involving all of the provided scores, and so on.

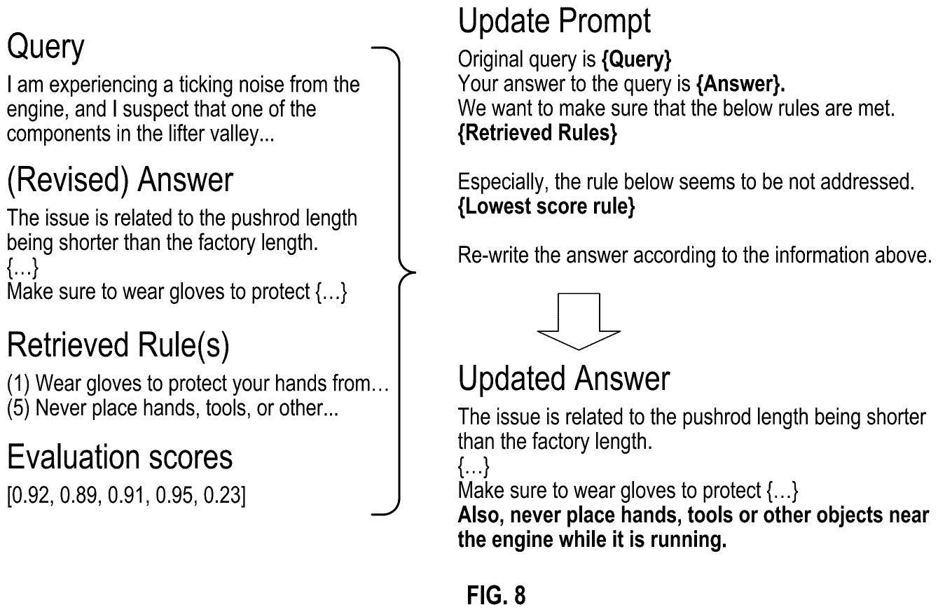

FIG. 8 illustrates an example of prompt construction 402 when the evaluation indicates that the answer needs to be revised, in accordance with an example implementation. Specifically, FIG. 8 incorporates the evaluations indicated in FIG. 6, which is processed to create a prompt as illustrated in FIG. 8, in which the rules that were not met from the retrieved rules are included in the prompt for the LLM as well as the indicated score for the insufficiently addressed rule. In response, the LLM provides an updated answer that can be re-evaluated according to the flow of FIG. 4. The updated answer in the example of FIG. 8 includes extra information to address the inadequately addressed rule.

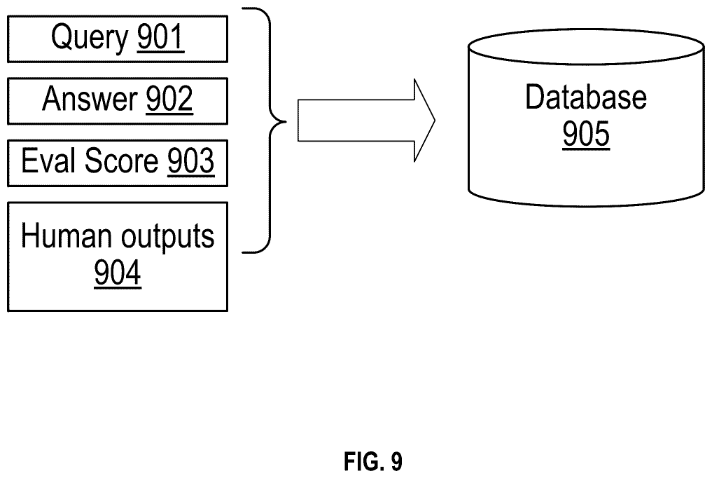

Once the answer is determined to be sufficient, then the outputs generated by the LLM along with the rule evaluation scores are displayed to the user at 406. At 407, user response is also collected if the answer needs to be revised, whereupon if required, a new prompt is constructed back at 402, and/or the user response along with the query, answer, and evaluations are saved at 408. In example implementations, users can directly revise the answer/query, etc., or the example implementations can provide multiple outputs to take an input regarding which output is preferred by the user. FIG. 9 illustrates an example architecture to save user feedback data, in accordance with an example implementation. As shown in FIG. 9, the query 901, answer 902, evaluation scores 903, and human outputs 904 are provided to the database 905.

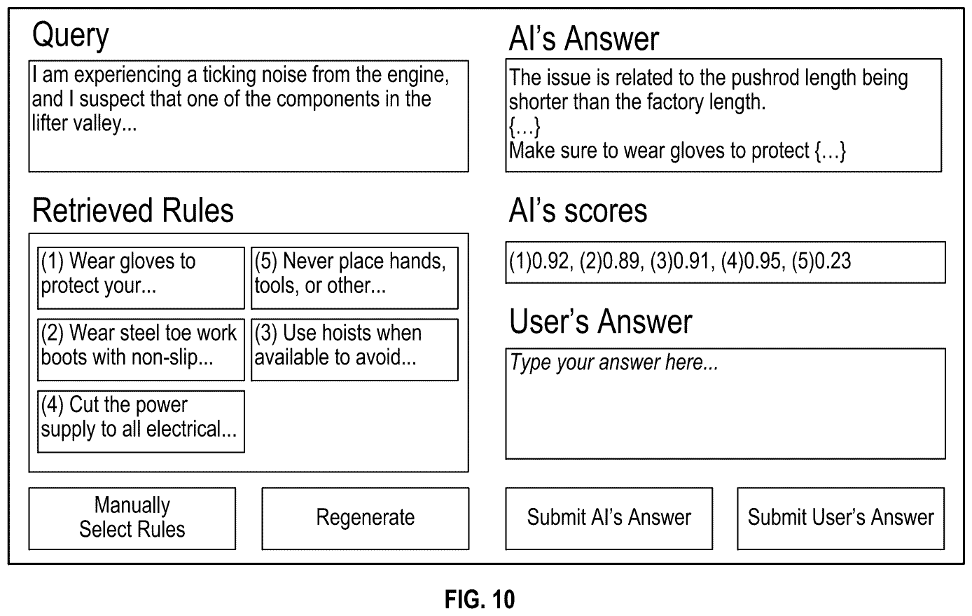

FIG. 10 illustrates an example user interface to obtain the user response 407, in accordance with an example implementation. FIG. 10 also illustrates an example interface to display the response to the user 406. As shown in FIG. 10, the information for display can include the query used, the answer from the LLM, the scores from the LLM, retrieved rules utilized, and any user freeform answer. Other options for the user response can include buttons to allow the user to manually select rules from the retrieved rules, to regenerate the answer, to submit the AI's answer as acceptable, or to submit the user's answer input into the user's answer box. If the manually select rules or regenerate option are selected, then the prompt is reconstructed at 402. If the AI's answer or the user's answer is submitted, then the answer is saved at 408.

Depending on the desired implementation, the user interface can also indicate whether the rules, mapping, or model is to be updated. If so (e.g., updated via submission of the AI's answer, the user's answer, updating rule selection, submitting a new mapping, etc.), then the flow can proceed to 200 to pre-process the input used to update the rules, mapping, or model, and then the flow proceeds to save the mapping/model at 409 into the database 905.

Through the example implementations described herein, it is possible to make LLMs explicitly follow domain-specific rules. The example implementations described herein further require less computation at generation and less computation when the rules are updated. Example implementations described herein can execute faster than related art LLM solutions that are compelled to be domain specific, and are compatible with models that cannot do any pre-training at all (e.g., proprietary or non-accessible solutions such as ChatGPT).

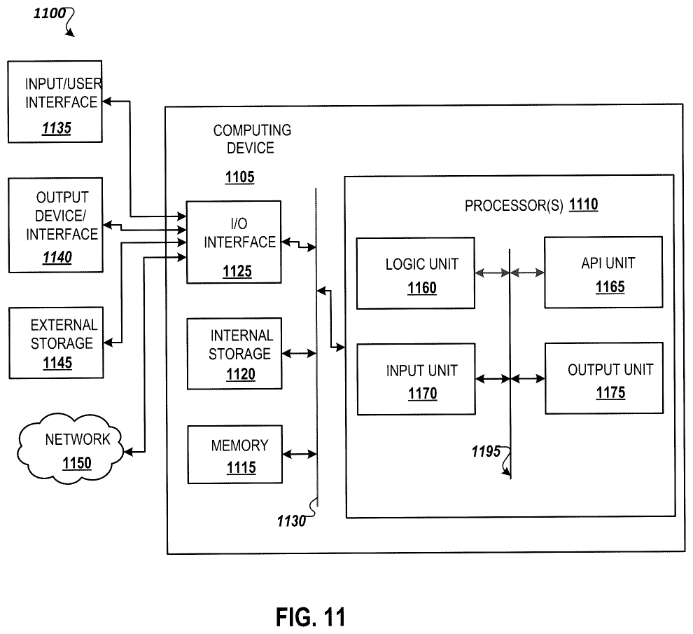

FIG. 11 illustrates an example computing environment with an example computer device suitable for use in some example implementations. Computer device 1105 in computing environment 1100 can include one or more processing units, cores, or processors 1110, memory 1115 (e.g., RAM, ROM, and/or the like), internal storage 1120 (e.g., magnetic, optical, solid state storage, and/or organic), and/or I/O interface 1125, any of which can be coupled on a communication mechanism or bus 1130 for communicating information or embedded in the computer device 1105. I/O interface 1125 is also configured to receive images from cameras or provide images to projectors or displays, depending on the desired implementation.

Computer device 1105 can be communicatively coupled to input/user interface 1135 and output device/interface 1140. Either one or both of input/user interface 1135 and output device/interface 1140 can be a wired or wireless interface and can be detachable. Input/user interface 1135 may include any device, component, sensor, or interface, physical or virtual, that can be used to provide input (e.g., buttons, touch-screen interface, keyboard, a pointing/cursor control, microphone, camera, braille, motion sensor, optical reader, and/or the like). Output device/interface 1140 may include a display, television, monitor, printer, speaker, braille, or the like. In some example implementations, input/user interface 1135 and output device/interface 1140 can be embedded with or physically coupled to the computer device 1105. In other example implementations, other computer devices may function as or provide the functions of input/user interface 1135 and output device/interface 1140 for a computer device 1105.

Examples of computer device 1105 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 1105 can be communicatively coupled (e.g., via I/O interface 1125) to external storage 1145 and network 1150 for communicating with any number of networked components, devices, and systems, including one or more computer devices of the same or different configuration. Computer device 1105 or any connected computer device can be functioning as, providing services of, or referred to as a server, client, thin server, general machine, special-purpose machine, or another label.

I/O interface 1125 can include, but is not limited to, wired and/or wireless interfaces using any communication or I/O protocols or standards (e.g., Ethernet, 802.11x, Universal System Bus, WiMax, modem, a cellular network protocol, and the like) for communicating information to and/or from at least all the connected components, devices, and network in computing environment 1100. Network 1150 can be any network or combination of networks (e.g., the Internet, local area network, wide area network, a telephonic network, a cellular network, satellite network, and the like).

Computer device 1105 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid state media (e.g., RAM, ROM, flash memory, solid-state storage), and other non-volatile storage or memory.

Computer device 1105 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 1110 can execute under any operating system (OS) (not shown), in a native or virtual environment. One or more applications can be deployed that include logic unit 1160, application programming interface (API) unit 1165, input unit 1170, output unit 1175, and inter-unit communication mechanism 1195 for the different units to communicate with each other, with the OS, and with other applications (not shown). The described units and elements can be varied in design, function, configuration, or implementation and are not limited to the descriptions provided. Processor(s) 1110 can be in the form of hardware processors such as central processing units (CPUs) or in a combination of hardware and software units.

In some example implementations, when information or an execution instruction is received by API unit 1165, it may be communicated to one or more other units (e.g., logic unit 1160, input unit 1170, output unit 1175). In some instances, logic unit 1160 may be configured to control the information flow among the units and direct the services provided by API unit 1165, input unit 1170, output unit 1175, in some example implementations described above. For example, the flow of one or more processes or implementations may be controlled by logic unit 1160 alone or in conjunction with API unit 1165. The input unit 1170 may be configured to obtain input for the calculations described in the example implementations, and the output unit 1175 may be configured to provide output based on the calculations described in example implementations.

Processor(s) 1110 can be configured to execute a method or computer instructions that can involve, for receipt of a domain-specific user query 202, a) generating an answer 401 from a large language model (LLM) to the domain-specific user query; b) constructing a prompt 402 from the answer and the domain-specific user query; c) generating 403 a mapping of the prompt to domain-specific rules; d) generating 403 an updated answer from the mapped domain-specific rules; e) evaluating the updated answer 404; and f) iterating steps b) to e) until the updated answer is evaluated to exceed a threshold, wherein the prompt is updated based on the evaluation for the updated answer being evaluated to not exceed the threshold; and storing 408 the domain-specific user query 901, the updated answer 902 and the evaluation 903 in a database 905 to update preprocessing for inputs of domain-specific user queries as illustrated in FIGS. 2 to 4 and FIG. 9.

Processor(s) 1110 can be configured to execute the method or instructions as described above, wherein the generating the mapping of the prompt to the domain-specific rules includes executing category mapping to determine one or more categories for the prompt, and rule category mapping to retrieve the domain-specific rules from the determined one or more categories to map to the prompt as illustrated in FIG. 5.

Processor(s) 1110 can be configured to execute the method or instructions as described above, and further include providing a user interface configured to provide the domain-specific user query, the updated answer, the mapped domain-specific rules (e.g., the retrieved rules) and the evaluation in response to the domain-specific user query; and reiterating steps b) to e) for receipt of a modification request made to the user interface as illustrated in FIG. 4 and FIG. 10. Depending on the desired implementation, the modification can include selection or deselection of ones of the domain-specific rules as illustrated in FIG. 10. As illustrated in FIGS. 9 and 10, the user interface can be configured to receive a user-specified replacement for the updated answer; wherein the storing further includes storing the user-specified replacement as the updated answer as shown at 904 of FIG. 9.

As illustrated in FIGS. 6 to 8, the evaluating the updated answer can be based on the mapped domain-specific rules being addressed in the updated answer.

Through the example implementations described herein, less computation is required when rules are updated; example implementations concentrate on generating the mapping between the categories, which is significantly easier task than what is done in the related art, which is making an LLM understand and follow the rules. This means that the example implementations utilize simpler training or mapping, which leads to much smaller computation resource required.

Through the example implementations described herein, the model can be made to explicitly follow domain-specific rules. As the example implementations does not rely on pre-training but rather applies the rules on-the-go at inference level, the LLMs can directly use these rules to generate more accurate answers. This makes the output of this method more reliable and can be trusted for use in industrial use cases.

Through the example implementations described herein, a faster response and less computation is required at generation. As the example implementations described herein reduces the number of rules at generation level, the amount of computation required at generation is significantly smaller than simply using all the rules to generate the output. Further the time required to generate the response is smaller.

Depending on the desired implementation, example implementations can combine with the pre-training the language model. For example, example implementations can use the rule mapping method to efficiently generate preference dataset that is utilized in the related art. Related art implementations generate the dataset by randomly sampling the rules, which is not applicable when the number of rules is large and not all of them are relevant. However, if the example implementations use the categorization technique at this stage, a small number of relevant rules can be taken, which makes this original method valid. By using the example implementations described herein, the pre-training of the model would be much more efficient, which can be feasible for frequently changing rules.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer-readable storage medium or a computer-readable signal medium. A computer-readable storage medium may involve tangible mediums such as, but not limited to optical disks, magnetic disks, read-only memories, random access memories, solid state devices and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the techniques of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit or can be spread across a number of components in any number of ways. When performed by software, the methods may be executed by a processor, such as a general-purpose computer, based on instructions stored on a computer-readable medium. If desired, the instructions can be stored on the medium in a compressed and/or encrypted format.

Moreover, other implementations of the present application will be apparent to those skilled in the art from consideration of the specification and practice of the techniques of the present application. Various aspects and/or components of the described example implementations may be used singly or in any combination. It is intended that the specification and example implementations be considered as examples only, with the true scope and spirit of the present application being indicated by the following claims.

What is claimed is:

1. A method, comprising:
for receipt of a domain-specific user query:
a) generating an answer from a large language model (LLM) to the domain-specific user query;
b) constructing a prompt from the answer and the domain-specific user query;
c) generating a mapping of the prompt to domain-specific rules;
d) generating an updated answer from the mapped domain-specific rules;
e) evaluating the updated answer; and
f) iterating steps b) to e) until the updated answer is evaluated to exceed a threshold, wherein the prompt is updated based on the evaluation for the updated answer being evaluated to not exceed the threshold; and
storing the domain-specific user query, the updated answer and the evaluation in a database to update preprocessing for inputs of domain-specific user queries.

2. The method of claim 1, wherein the generating the mapping of the prompt to the domain-specific rules comprises executing category mapping to determine one or more categories for the prompt, and rule category mapping to retrieve the domain-specific rules from the determined one or more categories to map to the prompt.

3. The method of claim 1, further comprising providing a user interface configured to provide the domain-specific user query, the updated answer, the mapped domain-specific rules and the evaluation in response to the domain-specific user query; and
reiterating steps b) to e) for receipt of a modification request made to the user interface.

4. The method of claim 3, wherein the modification comprises selection or deselection of ones of the domain-specific rules.

5. The method of claim 3, wherein the user interface is configured to receive a user-specified replacement for the updated answer;
wherein the storing further comprises storing the user-specified replacement as the updated answer.

6. The method of claim 1, wherein the evaluating the updated answer is based on the mapped domain-specific rules being addressed in the updated answer.

7. A non-transitory computer readable medium, comprising:
for receipt of a domain-specific user query:
a) generating an answer from a large language model (LLM) to the domain-specific user query;
b) constructing a prompt from the answer and the domain-specific user query;
c) generating a mapping of the prompt to domain-specific rules;
d) generating an updated answer from the mapped domain-specific rules;
e) evaluating the updated answer; and
f) iterating steps b) to e) until the updated answer is evaluated to exceed a threshold, wherein the prompt is updated based on the evaluation for the updated answer being evaluated to not exceed the threshold; and
storing the domain-specific user query, the updated answer and the evaluation in a database to update preprocessing for inputs of domain-specific user queries.

8. The non-transitory computer readable medium of claim 7, wherein the generating the mapping of the prompt to the domain-specific rules comprises executing category mapping to determine one or more categories for the prompt, and rule category mapping to retrieve the domain-specific rules from the determined one or more categories to map to the prompt.

9. The non-transitory computer readable medium of claim 7, further comprising providing a user interface configured to provide the domain-specific user query, the updated answer, the mapped domain-specific rules rules and the evaluation in response to the domain-specific user query; and
reiterating steps b) to e) for receipt of a modification request made to the user interface.

10. The non-transitory computer readable medium of claim 9, wherein the modification comprises selection or deselection of ones of the domain-specific rules.

11. The non-transitory computer readable medium of claim 9, wherein the user interface is configured to receive a user-specified replacement for the updated answer;
wherein the storing further comprises storing the user-specified replacement as the updated answer.

12. The non-transitory computer readable medium of claim 7, wherein the evaluating the updated answer is based on the mapped domain-specific rules being addressed in the updated answer.

13. An apparatus, comprising:
a processor, configured to:
for receipt of a domain-specific user query:
a) generate an answer from a large language model (LLM) to the domain-specific user query;
b) construct a prompt from the answer and the domain-specific user query;
c) generate a mapping of the prompt to domain-specific rules;
d) generate an updated answer from the mapped domain-specific rules;
e) evaluate the updated answer; and
f) iterate steps b) to e) until the updated answer is evaluated to exceed a threshold, wherein the prompt is updated based on the evaluation for the updated answer being evaluated to not exceed the threshold; and
store the domain-specific user query, the updated answer and the evaluation in a database to update preprocessing for inputs of domain-specific user queries.

14. The apparatus of claim 13, wherein the processor is configured to generate the mapping of the prompt to the domain-specific rules by executing category mapping to determine one or more categories for the prompt, and rule category mapping to retrieve the domain-specific rules from the determined one or more categories to map to the prompt.

15. The apparatus of claim 13, wherein the processor is further configured to provide a user interface configured to provide the domain-specific user query, the updated answer, the mapped domain-specific rules and the evaluation in response to the domain-specific user query; and
reiterate steps b) to e) for receipt of a modification request made to the user interface.

16. The apparatus of claim 15, wherein the modification comprises selection or deselection of ones of the domain-specific rules.

17. The apparatus of claim 15, wherein the user interface is configured to receive a user-specified replacement for the updated answer;
wherein the processor is further configured to store the user-specified replacement as the updated answer.

18. The apparatus of claim 13, wherein the processor is configured to evaluate the updated answer based on the mapped domain-specific rules being addressed in the updated answer.
